(19) United States
(12) Patent Application Publication
(10) Pub. No.: US 2017/0231362 A1
(43) Pub. Date: Aug. 17, 2017

(54) Unique Flow Sprayer

(71) Applicant: Betty Lyn Cooper, Syracuse, NY (US)

(72) Inventor: Betty Lyn Cooper, Syracuse, NY (US)

(21) Appl. No.: 15/041,730

(22) Filed: Feb. 11, 2016

(51) Int. Cl. A45D 34/00; B05B 11/00

(52) U.S. Cl. CPC A45D 34/00; B05B 11/3001; B05B 11/3047; A45D 2034/007

(57) ABSTRACT

This particular design is referring to a perfume bottle.

The tube inside the bottle is responsible for bringing the contents out of the bottle.

This Unique flow Sprayer is a device that is inserted into a container. It is designed to reach the contents of the container at every angle of the container. Each unique design of this nature has, as its primary purpose, the withdrawal of as much of the contents of the container as possible.

### CROSS REFERENCE

Provisional Patent Application number (

[symbol]

### FEDERAL SPONSORS

This creation has not been federally sponsored at this time. Jan. 7, 2014

### BACKGROUND

One morning, as I prepared for the day, I reached over to my favorite bottle of perfume and attempted to spray it. Although it was obvious that there was still liquid in the bottom of the container, it would not spray out. I thought then of a device that could reach both sides of the bottle, and no matter how I held the bottle it would spray the remaining liquid.

I contacted an invention company an presented the idea of the, “The Unique Flow Sprayer”. I paid $850.00 to have it researched. I later received a letter stating that it was a unique idea and I was congratulated.(Davidsons 2011)

The Unique Flow Sprayer is a device that is designed to allow the contents to be pulled from every angle possible with the expectation of using all of it's contents.

### DECLARATION

I have invented The Unique Flow Sprayer, a new design for a device that can get most, if not all of the contents in a container.

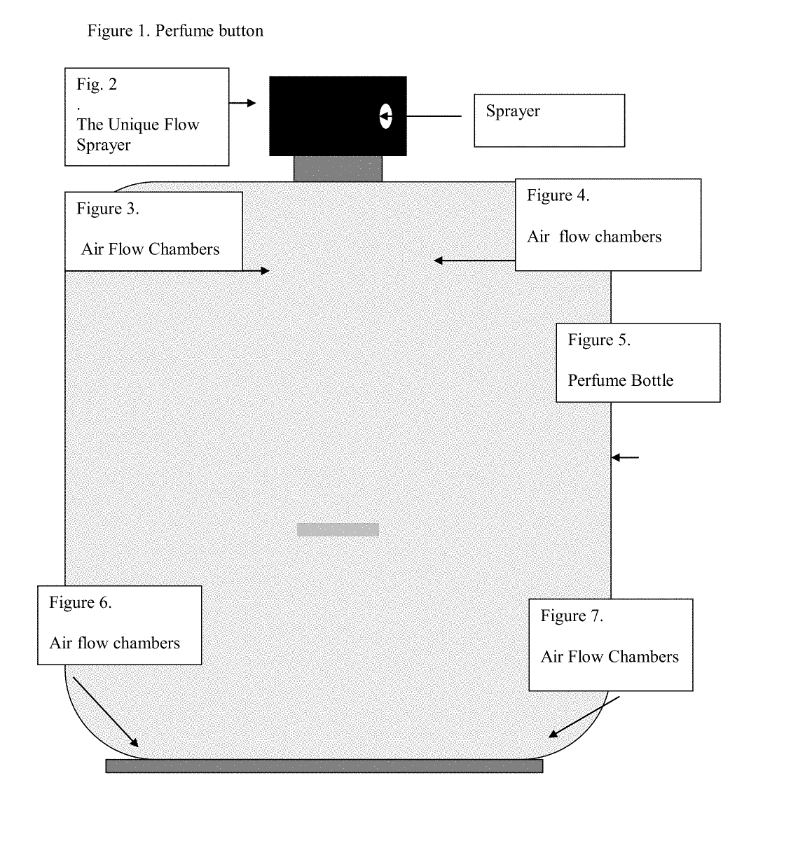

FIG. 1 is the top of a perfume bottle.

FIG. 2 a device designed to bring the perfume out of the bottle.

FIGS. 3, 4, 6 and 7 are the openings to draw the liquid out

FIG. 5 a sample perfume bottle shape.

1. I have invented The Unique Flow Sprayer, a new design for a device that can get most, if not all of the contents in a perfume container.

2. The devices will be designed to allow the contents to be pulled from any container from every angle possible with the expectation of using all of it's contents.
